(19) United States
(12) Patent Application Publication
(10) Pub. No.: US 2015/0149354 A1
(43) Pub. Date: May 28, 2015

(54) Real-Time Data Recognition and User Interface Field Updating During Voice Entry

(71) Applicant: Bank of America Corporation, Charlotte, NC (US)

(72) Inventor: David Cooper McCoy, Charlotte, NC (US)

(73) Assignee: Bank of America Corporation, Charlotte, NC (US)

(21) Appl. No.: 14/092,118

(22) Filed: Nov. 27, 2013

(51) Int. Cl. G06Q 20/10; G10L 15/08; G10L 17/22

(52) U.S. Cl. CPC G06Q 20/108; G10L 17/22; G10L 15/08
USPC 705/42

(57) ABSTRACT

According to some embodiments, an apparatus comprises a microphone, one or more processors, and a display. The microphone receives a spoken command. The one or more processors communicate the spoken command to a server and receive an interpretation of the spoken command from the sever. The interpretation of the spoken command comprises information identifying a type of online banking transaction, information identifying one or more fields associated with the type of online banking transaction, and information identifying transactional data included in the spoken command. The one or more processors also populate each of the one or more fields for which the spoken command includes transactional data with the respective transactional data associated with each field. The display displays a pre-confirmation screen. The pre-confirmation screen comprises the one or more fields populated with the respective transactional data.

### TECHNICAL FIELD OF THE INVENTION

This invention relates generally to online banking transactions, and more particularly to voice entry for online banking transactions.

### BACKGROUND

Online banking transactions typically involve a user entering a great deal of information into an online banking application through a touchscreen on a mobile device, such as a smart phone, PDA, or tablet computer. Entering the information required for an online banking transaction through a touchscreen may require a great number of taps or touches on the touchscreen. A user who has to enter a large number of taps or touches on a touch screen may grow frustrated at the time it takes to enter the data needed for an online banking transaction.

### SUMMARY

According to some embodiments, an apparatus comprises a microphone, one or more processors, and a display. The microphone receives a spoken command. The one or more processors communicate the spoken command to a server and receive an interpretation of the spoken command from the sever. The interpretation of the spoken command comprises information identifying a type of online banking transaction, information identifying one or more fields associated with the type of online banking transaction, and information identifying transactional data included in the spoken command. The one or more processors also populate each of the one or more fields for which the spoken command includes transactional data with the respective transactional data associated with each field. The display displays a pre-confirmation screen. The pre-confirmation screen comprises the one or more fields populated with the respective transactional data.

Certain embodiments of the invention may provide one or more technical advantages. A technical advantage of one embodiment includes receiving data needed for an online banking transaction by voice command. Receiving data needed for an online banking transaction by voice command allows a user to enter data without having to make a large number of touches on a touchscreen, this may be faster and more convenient for a user.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example of system for conducting online banking transactions using voice commands;

FIG. 2 illustrates additional details of a client for conducting online banking transactions;

FIG. 3 illustrates an example of a display screen for an online banking application that accepts voice commands; and

FIG. 4 illustrates an example flowchart for conducting an online banking transaction using voice commands.

### DETAILED DESCRIPTION OF THE DRAWINGS

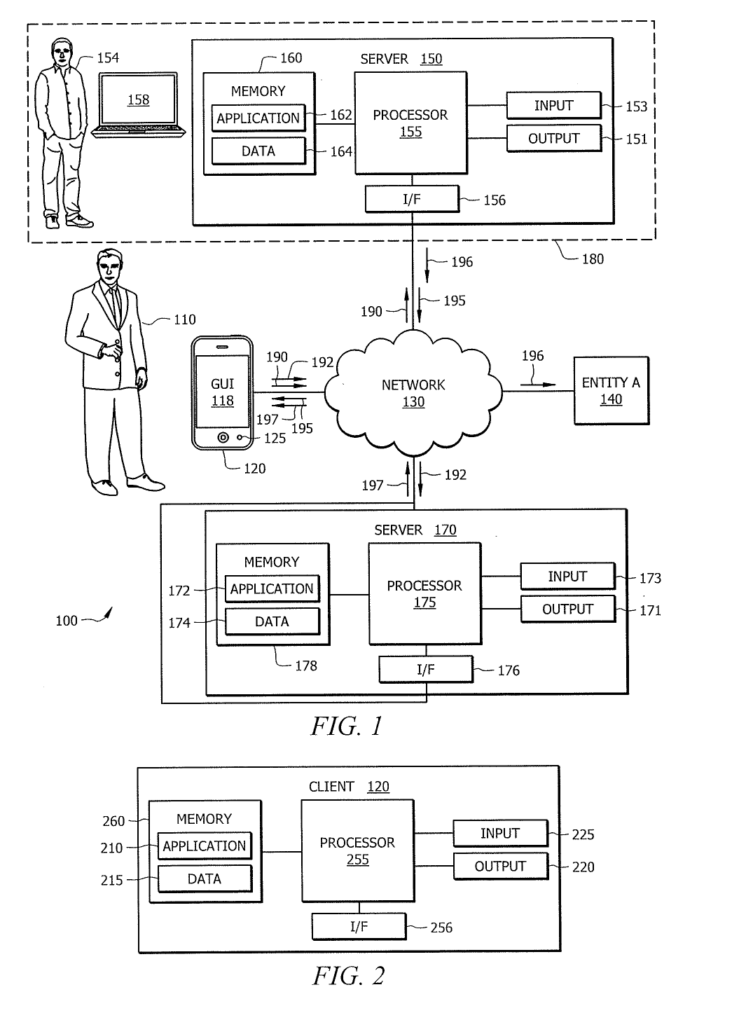

Embodiments of the present invention and its advantages are best understood by referring to FIGS. 1 through 4 of the drawings, like numerals being used for like and corresponding parts of the various drawings.

Online banking transactions typically require entry of multiple pieces of data into an application for online banking transactions on a mobile device. For example, a user wishing to complete a payment to another party must enter at least the name of the party, an amount the user wishes to pay, and the date on which such a payment would take place. Entering this information into a mobile device by a touch screen may require a great number of touches on the screen.

The teachings of this disclosure recognize that it would be desirable to reduce the number of touches necessary for a user to make an online banking transaction. Accordingly, in some embodiments, an online banking application may allow a user to make a payment using voice commands. For example, the user may speak the name of the party to be paid, the amount of payment, and the date of payment to a mobile device that enters the information into an online banking application without the user having to touch the screen. The online banking application may provide voice entry to facilitate online banking transactions that use fewer screen touches than would be required for typical online banking transactions.

FIGS. 1 through 4 below illustrate a system and method for using voice entry to conduct online banking transactions. For purposes of example and illustration, FIGS. 1 through 4 are described with respect to a payment transaction. However, the present disclosure contemplates facilitation of other types of transactions using voice entry, such as transfers, deposits, and loan applications, which may include more or fewer fields than a payment transaction.

FIG. 1 illustrates an example of a system 100 that uses voice entry to conduct online banking transactions. System 100 may include one or more users 110, one or more clients 120, one or more entities 140, one or more servers 170, and an enterprise 180 comprising one or more servers 150. Clients 120, entities 140, servers 150, and servers 170 may be communicatively coupled by network 130.

In some embodiments, user 110 may be interested in making an online banking transaction. For example, user 110 may wish to make a payment to an entity 140. To make an online banking transaction, user 110 may use client 120. Client 120 may refer to a computing device associated with user 110, such as a smartphone, a tablet computer, a personal digital assistant (PDA), a laptop computer, or other computing device.

In general, one or more servers 170 may receive requests 192 and provide responses 197 to user 110. User 110 may initiate one or more requests 192 during an online banking transaction. Requests 192 may comprise requests to interpret a spoken command accompanied by data representing the spoken command (e.g., a waveform, compressed audio data, or the like). In particular embodiments, requests 192 may be communicated in real-time as user 110 speaks commands. Responses 197 may comprise an interpretation of a spoken command comprising information identifying a type of transaction, fields associated with the transaction, and transactional data associated with the fields. In particular embodiments, the transactional data may comprise textual information. Responses 197 may be communicated in real-time in response to requests 192.

In general, one or more servers 150 may receive request 190 and provide response 195 to user 110 and response 196 to entity 140. User 110 may initiate one or more different types of requests 190 during an online banking transaction. Examples of different types of requests 190 include payment requests or transfer requests. Responses 195 and 196 may be tailored according to the type of request 190.

A payment request may be used to make a payment to an entity 140. Response 196 may comprise the payment to entity 140 and response 195 may comprise a confirmation of the payment to user 110 via client 120. The confirmation of the payment made in response 195 may include the amount paid, the date of payment, and the name of entity 140 to which user 110 made the payment.

In some embodiments, a transfer request may be used to make a transfer to an entity 140. Response 196 may comprise the transfer to entity 140 and response 195 may comprise a confirmation of the transfer to user 110 via client 120. The confirmation of the transfer made in response 195 may include the amount transferred, the date of the transfer, and the name of entity 140 to which the transfer was made. Although this example describes transferring funds to an entity 140, in other embodiments the transfer may be made to an individual or between accounts associated with user 110 (e.g., user 110 may transfer funds from the user's savings account to the user's checking account).

Client 120 may refer to any device that enables user 110 to interact with server 150. In some embodiments, clients 120 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Clients 120 may also comprise any suitable user interface such as a display, microphone 125, keyboard, or any other appropriate terminal equipment usable by a user 110. It will be understood that system 100 may comprise any number and combination of clients 120.

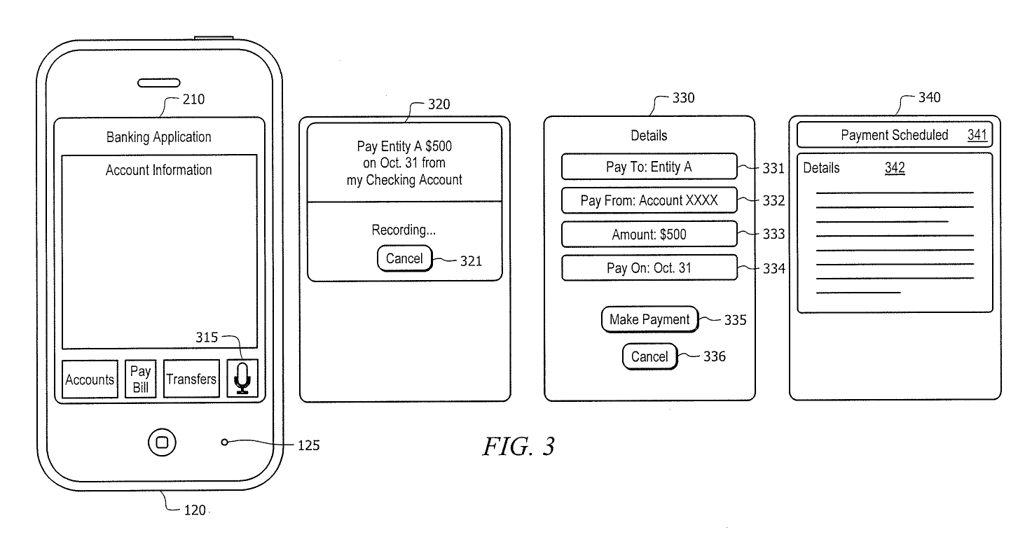

Client 120 may enable user 110 to interact with server 150 in order to send request 190 and receive response 195. In some embodiments, client 120 may include an application that uses spoken commands to facilitate online banking transactions. An example of a display screen of an application that uses voice commands is described with respect to FIG. 3 below.

In some embodiments, client 120 may include a graphical user interface (GUI) 118. GUI 118 is generally operable to tailor and filter data entered by and presented to user 110. GUI 118 may provide user 110 with an efficient and user-friendly presentation of request 190 and/or response 195. GUI 118 may comprise a plurality of displays having interactive fields, pull-down lists, and buttons operated by user 110. GUI 118 may be operable to display data converted from speech spoken by user 110. GUI 118 may include multiple levels of abstraction including groupings and boundaries. It should be understood that the term GUI 118 may be used in the singular or in the plural to describe one or more GUIs 118 and each of the displays of a particular GUI 118.

In certain embodiments, network 130 may refer to any interconnecting system capable of transmitting audio, video, signals, data, messages, or any combination of the preceding. Network 130 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

Server 170 may refer to one or more computer systems that facilitate parsing and/or interpreting voice commands. In some embodiments, server 170 may refer to any suitable combination of hardware and/or software implemented in one or more modules to process data and provide the described functions and operations. In some embodiments, the functions and operations described herein may be performed by a pool of servers 170. In other embodiments the functions described herein may be performed by a group of servers 170 comprising a group of cloud based servers. In some embodiments, server 170 may include, for example, a mainframe, server, host computer, workstation, web server, file server, a personal computer such as a laptop, or any other suitable device operable to process data. In some embodiments, server 170 may execute any suitable operating system such as IBM's zSeries/Operating System (z/OS), MS-DOS, PC-DOS, MAC-OS, WINDOWS, UNIX, OpenVMS, cloud based operating systems, or any other appropriate operating systems, including future operating systems.

In general, server 170 receives requests 192, determines responses 197, and communicates responses 197 to user 110. In some embodiments, servers 170 may include a processor 175, server memory 178, an interface 176, an input 173, and an output 171. Server memory 178 may refer to any suitable device capable of storing and facilitating retrieval of data and/or instructions. Examples of server memory 178 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 1 illustrates server memory 178 as internal to server 170, it should be understood that server memory 178 may be internal or external to server 170, depending on particular implementations. Also, server memory 178 may be separate from or integral to other memory devices to achieve any suitable arrangement of memory devices for use in system 100.

Server memory 178 is generally operable to store an application 172 and data 174. Application 172 generally refers to logic, rules, algorithms, code, tables, and/or other suitable instructions for performing the described functions and operations. In some embodiments, application 172 facilitates determining information to include in responses 197. Data 174 may include data associated with interpreting a spoken command, such as data for converting speech to text, data for identifying online banking transactions, data for determining necessary information for an online banking transaction, and so on.

Server memory 178 communicatively couples to processor 175. Processor 175 is generally operable to execute application 172 stored in server memory 178 to provide response 197 according to the disclosure. Processor 175 may comprise any suitable combination of hardware and software implemented in one or more modules to execute instructions and manipulate data to perform the described functions for servers 170. In some embodiments, processor 175 may include, for example, one or more computers, one or more central processing units (CPUs), one or more microprocessors, one or more applications, and/or other logic.

In some embodiments, communication interface 176 (I/F) is communicatively coupled to processor 175 and may refer to any suitable device operable to receive input for server 170, send output from server 170, perform suitable processing of the input or output or both, communicate to other devices, or any combination of the preceding. Communication interface 176 may include appropriate hardware (e.g., modem, network interface card, etc.) and software, including protocol conversion and data processing capabilities, to communicate through network 130 or other communication system, which allows server 170 to communicate to other devices. Communication interface 176 may include any suitable software operable to access data from various devices such as clients 120, servers 150, and/or entities 140. Communication interface 176 may also include any suitable software operable to transmit data to various devices such as clients 120, servers 150, and/or entities 140. Communication interface 176 may include one or more ports, conversion software, or both. In general, communication interface 176 receives requests 192 from clients 120 and communicates responses 197 to clients 120.

In some embodiments, input device 173 may refer to any suitable device operable to input, select, and/or manipulate various data and information. Input device 173 may include, for example, a keyboard, mouse, graphics tablet, joystick, light pen, microphone, scanner, or other suitable input device. Output device 171 may refer to any suitable device operable for displaying information to a user. Output device 171 may include, for example, a video display, a printer, a plotter, or other suitable output device.

In operation, application 172, upon execution by processor 175, facilitates determining response 197 and providing response 197 to client 120. To provide response 197, application 172 may first receive request 192 from user 110 via client 120. In some embodiments, GUI 118 may provide locations for user 110 to enter request 192 and/or to select from a list of account-specific options associated with an account of user 110 for request 192. Request 192 may comprise a request to interpret a spoken command accompanied by voice data representing the spoken command.

Once application 172 receives request 192, application 172 determines response 197. Application 172 may perform any suitable steps for determining response 197 according to the type of request 192. In the following example, application 172 receives request 192 requesting interpretation of a spoken command, and application 172 interprets the spoken command and returns the interpretation of the spoken command to client 120 in response 197. Application 172 may interpret the spoken command by converting the spoken command into text, and parsing the text. In particular embodiments, response 197 may comprise an interpretation of a spoken command comprising information identifying a type of transaction, fields associated with the type of transaction, and transactional data associated with the fields. In particular embodiments, the transactional data may comprise textual information.

Enterprise 180 may refer to a bank or other financial institution that facilitates financial transactions. In some embodiments, enterprise 180 may include one or more servers 150, an administrator workstation 158, and an administrator 154. In some embodiments, server 150 may refer to any suitable combination of hardware and/or software implemented in one or more modules to process data and provide the described functions and operations. In some embodiments, the functions and operations described herein may be performed by a pool of servers 150. In some embodiments, server 150 may include, for example, a mainframe, server, host computer, workstation, web server, file server, a personal computer such as a laptop, or any other suitable device operable to process data. In some embodiments, server 150 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 150 receives request 190, determines responses 195 and 196, and provides response 195 to user 110 and response 196 to entity 140. In some embodiments, servers 150 may include a processor 155, server memory 160, an interface 156, an input 153, and an output 151. Server memory 160 may refer to any suitable device capable of storing and facilitating retrieval of data and/or instructions. Examples of server memory 160 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 150, it should be understood that server memory 160 may be internal or external to server 150, depending on particular implementations. Also, server memory 160 may be separate from or integral to other memory devices to achieve any suitable arrangement of memory devices for use in system 100.

Server memory 160 is generally operable to store an application 162 and user data 164. Application 162 generally refers to logic, rules, algorithms, code, tables, and/or other suitable instructions for performing the described functions and operations. In some embodiments, application 162 facilitates determining information to include in responses 195 and 196. User data 164 may include data associated with user 110 such as a password for accessing an application, buyer preferences, account information, and/or account balances and so on.

Server memory 160 communicatively couples to processor 155. Processor 155 is generally operable to execute application 162 stored in server memory 160 to provide responses 195 and 196 according to the disclosure. Processor 155 may comprise any suitable combination of hardware and software implemented in one or more modules to execute instructions and manipulate data to perform the described functions for servers 150. In some embodiments, processor 155 may include, for example, one or more computers, one or more central processing units (CPUs), one or more microprocessors, one or more applications, and/or other logic.

In some embodiments, communication interface 156 (I/F) is communicatively coupled to processor 155 and may refer to any suitable device operable to receive input for server 150, send output from server 150, perform suitable processing of the input or output or both, communicate to other devices, or any combination of the preceding. Communication interface 156 may include appropriate hardware (e.g., modem, network interface card, etc.) and software, including protocol conversion and data processing capabilities, to communicate through network 130 or other communication system, which allows server 150 to communicate to other devices. Communication interface 156 may include any suitable software operable to access data from various devices such as clients 120, servers 170, and/or entities 140. Communication interface 156 may also include any suitable software operable to transmit data to various devices such as clients 120, servers 170, and/or entities 140. Communication interface 156 may include one or more ports, conversion software, or both. In general, communication interface 156 receives requests 190 from clients 120 and transmits responses 195 to clients 120 and responses 196 to entities 140.

In some embodiments, input device 153 may refer to any suitable device operable to input, select, and/or manipulate various data and information. Input device 153 may include, for example, a keyboard, mouse, graphics tablet, joystick, light pen, microphone, scanner, or other suitable input device. Output device 151 may refer to any suitable device operable for displaying information to a user. Output device 151 may include, for example, a video display, a printer, a plotter, or other suitable output device.

In general, administrator 154 may interact with server 150 using an administrator workstation 158. In some embodiments, administrator workstation 158 may be communicatively coupled to server 150 and may refer to any suitable computing system, workstation, personal computer such as a laptop, or any other device operable to process data. In certain embodiments, an administrator 154 may utilize administrator workstation 158 to manage server 150 and any of the data stored in server memory 160.

In operation, application 162, upon execution by processor 155, facilitates determining response 195 and providing response 195 to client 120, as well as determining response 196 and providing response 196 to entities 140. To provide responses 195 and 196, application 162 may first receive request 190 from users 110 via clients 120. In some embodiments, GUI 118 may provide locations for user 110 to enter request 190 and/or to select from a list of account-specific options associated with an account of user 110 for request 190. Request 190 may include one or more identifiers indicating the type of request. Examples of requests include a payment request and a transfer request.

Once application 162 receives request 190, application 162 determines responses 195 and 196. Application 162 may perform any suitable steps for determining responses 195 and 196 according to the type of request 190. In the following example, application 162 receives request 190 specifying a payment request, and application 162 confirms the payment to user 110 in response 195 and makes the payment to entity 140 in response 196.

FIG. 2 illustrates additional details of client 120. In some embodiments, client 120 may include a processor 255, client memory 260, an interface 256, an input 225, and an output 220. Client memory 260 may refer to any suitable device capable of storing and facilitating retrieval of data and/or instructions. Examples of client memory 260 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 2 illustrates client memory 260 as internal to client 120, it should be understood that client memory 260 may be internal or external to client 120, depending on particular implementations.

Client memory 260 is generally operable to store an online banking application 210 and user data 215. Online banking application 210 generally refers to logic, rules, algorithms, code, tables, and/or other suitable instructions for performing the described functions and operations. User data 215 may include data associated with user 110 such as a password for accessing an application, buyer preferences, and/or account information and so on.

In some embodiments, online banking application 210, when executed by processor 255, facilitates determining information to include in requests 190 and 192. For example, online banking application 210 may receive a spoken command through an input 225, such as a microphone. Online banking application 210 may interpret the spoken command by identifying a type of online banking transaction and one or more fields associated with the type of online banking transaction. As an example, online banking application 210 may identify the type of transaction as a payment transaction and may identify the fields associated with the payment transaction as payee, payor account (e.g., user 110 may specify to make the payment from user 110's checking account or user 110's savings account), payment amount, and payment date. Online banking application 210 may then identify transactional data from the spoken command and may populate the fields for which the spoken command includes transactional data. For example, if the spoken command corresponds to “Pay $50 to Phone Company A,” online banking application 210 may populate “Phone Company A” as the payee and “$50” as the payment amount. Online banking application 210 may display a pre-confirmation screen showing “Phone Company A” and “$50” in the corresponding fields. Online banking application 210 may populate the payor account and payment date fields with blank values to remind user 110 that online banking application 210 needs additional information to complete request 190.

In alternative embodiments, online banking application 210, when executed by processor 255 may receive a spoken command through microphone 125, and generate request 192. Request 192 may be sent to servers 170 for application 172 to interpret the spoken command. For example, application 172 may receive a spoken command through request 192. Application 172 may interpret the spoken command by identifying a type of online banking transaction and one or more fields associated with the type of online banking transaction. As an example, application 172 may identify the type of transaction as a payment transaction and may identify the fields associated with the payment transaction as payee, payor account (e.g., user 110 may specify to make the payment from user 110's checking account or user 110's savings account), payment amount, and payment date. Application 172 may then identify transactional data from the spoken command and may populate the fields for which the spoken command includes transactional data. For example, if the spoken command corresponds to “Pay $50 to Phone Company A,” application 172 may populate determine that “Phone Company A” is the payee and “$50” is the payment amount. Application 172 may return the information it determined from the spoken command to client 120 in response 197. Upon receiving response 197, online banking application 210 may display a pre-confirmation screen showing “Phone Company A” and “$50” in the corresponding fields. Online banking application 210 may populate the payor account and payment date fields with blank values to remind user 110 that online banking application 210 needs additional information to complete request 190.

Online banking application 210 may communicate requests 192 to server 170 in real-time as user 110 speaks. Application 172 may interpret the spoken commands communicated by requests 192 in real-time and return responses 197 as the spoken commands are interpreted. Upon receiving a response 197 online banking application 210 may display information contained in the response 197 in real-time as responses 197 are received. For example, user 110 may speak the command “Pay Phone Company A” to client 120, causing online banking application 210 to communicate request 192, including voice data representing the spoken command “Pay Entity A,” to server 170. Application 172 may interpret the spoken command by determine that they type of transaction requested is a payment, and “Entity A” is the payee of the payment. Application 172 may return the information of the spoken command in response 197. Upon receiving response 197, online banking application 210 may display the information communicated by response 197. User 110 may speak an additional command, such as “$50,” causing online banking application 210 to communicate another request 192 to server 170. Application 172 may interpret additional spoken commands and return responses 197 as described above until online banking application 210 or application 172 determine that all necessary information for the banking transaction has been received. In particular embodiments, response 197 may contain a message to prompt user 110 for additional information needed to complete the banking transaction. For example, response 197 may cause online banking application 210 to display a message or play an audio message asking “How much do you want to pay?”, “When do you want to pay?”, or the like.

Client memory 260 communicatively couples to processor 255. Processor 255 is generally operable to execute online banking application 210 stored in client memory 260 to provide requests 190 and 192 according to the disclosure. Processor 255 may comprise any suitable combination of hardware and software implemented in one or more modules to execute instructions and manipulate data to perform the described functions for clients 120. In some embodiments, processor 155 may include, for example, one or more computers, one or more central processing units (CPUs), one or more microprocessors, one or more applications, and/or other logic.

In some embodiments, communication interface 256 (I/F) is communicatively coupled to processor 255 and may refer to any suitable device operable to receive input for client 120, send output from client 120, perform suitable processing of the input or output or both, communicate to other devices, or any combination of the preceding. Communication interface 256 may include appropriate hardware (e.g., modem, network interface card, etc.) and software, including protocol conversion and data processing capabilities, to communicate through network 130 or other communication system, which allows client 120 to communicate to other devices. Communication interface 256 may include any suitable software operable to access data from various devices such as servers 150, servers 170, and/or entities 140. Communication interface 256 may also include any suitable software operable to transmit data to various devices such as servers 150, servers 170, and/or entities 140. Communication interface 256 may include one or more ports, conversion software, or both. In general, communication interface 256 transmits requests 190 and 192 from clients 120 and receives response 195 from servers 150 and response 197 from servers 170.

In some embodiments, input device 225 may refer to any suitable device operable to input, select, and/or manipulate various data and information. Input device 225 may include, for example, a keyboard, mouse, graphics tablet, joystick, light pen, microphone 125, scanner, touch screen or other suitable input device. Output device 220 may refer to any suitable device operable for displaying information to a user. Output device 220 may include, for example, a video display, a printer, a plotter, or other suitable output device.

FIG. 3 illustrates an example of a display screen that an online banking application 210 installed on client 120 communicates to user 110. In some embodiments, user 110 may access online banking application 210 using manual commands (e.g., touchscreen or keyboard commands). Alternatively, user 110 may access online banking application 210 using spoken commands. As an example, online banking application 210 may interact with voice recognition software installed on client 120 such that online banking application 210 launches in response to keywords such as “pay” or “payment.” Upon accessing online banking transaction application 210, user 110 may be presented with a voice command icon 315, in certain embodiments. User 110 may select voice command icon 315 to prepare online banking transaction application 210 to accept voice commands through microphone 125.

After selecting voice command icon 315, user 110 may speak a command describing an online banking transaction to client 120. As user 110 speaks a command, online banking application 210 may interpret the spoken command. In some embodiments, online banking application 210 may interpret a spoken command by converting the command into text.

Alternatively, online banking application 210 may record a spoken command, and communicate the spoken command as request 192 for application 172 to interpret. Application 172 may interpret the spoken command as described below and return response 197 comprising the interpretation of the spoken command. Online banking application 210 may display text in voice command window 320 displaying text of the command that user 110 speaks. The text displayed in voice command window 320 may be displayed in real-time as user 110 speaks the command, in particular embodiments.

In the event that voice command window 320 does not display an accurate textual rendition of the spoken command or user 110 decides to enter another command, user 110 may selected cancel button 321. Selecting cancel button 321 may allow user 110 to speak a new command. In alternative embodiments, user 110 may speak a phrase such as “Cancel” or “Stop” to allow user 110 to speak a different or corrected command.

Online banking application 210 or application 172 may further interpret a spoken command by identifying a type of transaction described in the spoken command and one or more fields 331, 332, 333 and 334 associated with the type of transaction. Identified fields may include some or all of the information needed by online banking application 210 to complete a transaction described by a spoken command. For example, if user 110 wishes to make a payment, user 110 make speak the command “Pay Entity A 500 dollars on October 31st from my checking account.” Online banking application 210 or application 172 may interpret this command causing online banking application 210 to display a textual rendition of the spoken command in voice command window 320. Online banking application 210 or application 172 may identify the type of transaction as a payment. Online banking application 210 or application 172 may identify the type of transaction as a payment by recognizing certain phrases such as “Pay” or “Make a payment to.”

After identifying a type of transaction described by a spoken command, online banking application 210 or application 172 may identify fields associated with that transaction. For example, if online banking application 210 or application 172 identifies a transaction as a payment, online banking application 210 or application 172 may identify a field 331 to contain “pay to” information for the entity to be paid, a field 332 to contain “pay from” information describing an account of user 110 for making the payment (e.g., user 110's checking account, savings account, or other account), a field 333 to contain “payment amount” information of an amount being paid, and a field 334 to contain “payment date” information of the date of payment.

Once online banking application 210 or application 172 has identified the type of banking transaction and the fields associated with that type of banking transaction, online banking application 210 or application 172 may identify transactional data contained in a spoken command. Online banking application 210 or application 172 may identify transactional data by converting a spoken command into text and then parsing the text. Online banking application 210 or application 172 may associate identified transactional data with respective identified fields. For example, if user 110 speaks the command “Pay Entity A 500 dollars on October 31st from my checking account,” online banking application 210 or application 172 may identify the name of the entity to be paid as “Entity A” and associate that data with field 331.

Online banking application 210 may store information about user 110, in certain embodiments. In alternative embodiments online banking application 210 may retrieve information about user 110 stored on servers 150. For example, online banking application 210 may store or retrieve from servers 150 a list of accounts owned by user 110. Online banking application 210 may use stored or retrieved information about user 110 to associate identified transaction data with an identified field contained in a spoken command. For example, if user 110 speaks the command “Pay Entity A 500 dollars on October 31st from my checking account,” online banking application 210 or 172 may identify “my checking account” as transactional data included in the spoken command and cause application 210 to associate the checking account number stored for user 110 with field 332.

After interpreting a spoken command from user 110, or receiving an interpretation of the spoken command through response 197, online banking application 210 may display pre-confirmation screen 330. Pre-confirmation screen 330 may display the interpretation of the spoken command to user 110. Pre-confirmation screen may display fields associated with the type of transaction described by the spoken command, and display transactional data contained in the spoken command that is associated with each field. For example, if user 110 speaks the command “Pay Entity A 500 dollars on October 31 from my checking account,” online banking application 210 may display pre-confirmation screen containing fields 331, 332, 333, and 334 populated by transactional data included in the spoken command. In this example, field 331 may be populated with the name of the entity 140 to be paid, “Entity A,” field 332 may be populated with the account number, last four digits, or account nickname of the account number of user 110's checking account, “Account XXXX,” field 333 may be populated with the amount to be paid, “$500,” and field 334 may be populated with the date of payment, “Oct. 31.”

If a spoken command does not contain transaction data associated with a field, pre-confirmation screen 330 may display that field containing no data. For example, if user 110 speaks the command “Pay Entity A $500” pre-confirmation screen 330 may display field 333 and 334 as empty. A blank field may prompt user 110 to enter missing transactional data. In particular embodiments, blank fields may be highlighted to indicate to user 110 that information is needed. For example, a field that is blank may be highlighted in red, and a field that is complete may be highlighted in green. Alternatively, fields may contain a visual indication, such as a check box, indicating whether the information needed by the field has been entered. An unchecked check box may indicate that more information is needed while a checked check box may indicate that the field is complete. Additionally, if user 110 speaks information that is outside of an acceptable limit for the field, online banking application 210 may provide a visual indication that additional information is needed. For example, if user 110 speaks a date in the past, or an amount for payment that exceeds the funds in one of user 110's accounts, online banking application 210 may cause the field to be displayed in red.

Blank fields may be displayed in real-time as user 110 begins to speak so that user 110 knows what information online banking application 210 needs user 110 to say in order to configure the transaction. In embodiments in which online banking application 210 communicates the spoken command to servers 170 for interpretation by application 172, online banking application may communicate requests 192 comprising the spoken command continuously in real-time as user 110 speaks the command and application 172 may interpret the command and return response 197 continuously in real-time. Online banking application 210 may then populate blank fields in real-time with information received from application 172. Blank fields may act as prompts for user 110 to enter additional information.

User 110 may enter the missing data according to any suitable technique. As an example, user 110 may enter the missing date by spoken command, in certain embodiments. For example, if field 334 is empty user 110 may say “Pay on October 31.” Online banking application 210 or application 172 may interpret this spoken command, identify date of payment transactional data, and populate field 334 with the transactional data on pre-confirmation screen 330. Alternatively, user 110 may select a particular field and speak a command containing transactional data associated with that field. For example, user 110 may select field 333 by tapping field 333 on the screen of client 120, speak the command “500 dollars,” and online banking application 210 or application 172 may identify transactional data associated with field 333. In yet another alternative, user 110 may select a particular field and enter transactional data through and input device 225, such as a keyboard or touch screen. For example, user 110 may select field 333 by tapping field 333 on the screen of client 120 and enter an amount user 110 wishes to pay by typing the amount.

Additionally, user 110 may correct or change transactional data displayed in pre-confirmation screen 220. User 110 may change the transactional data by spoken command, in certain embodiments. For example, if user 110 wishes to change field 334 from “Oct. 31” to “Oct. 30,” user 110 may say “Pay on October 30.” In response, online banking application 210 or application 172 may interpret this spoken command, identify date of payment transactional data, and populate field 334 with the transactional data on pre-confirmation screen 330. Alternatively, user 110 may manually select a particular field and speak a command containing transactional data associated with that field to change the transactional data for that field. For example, user 110 may select field 333 by tapping field 333 on the screen of client 120 and may speak the command “550 dollars.” In response, online banking application 210 or application 172 may identify transactional data associated with field 333 and display “$550” in field 333 on pre-confirmation screen 330. In yet another alternative, user 110 may manually select a particular field and manually enter transactional data through an input device 225, such as a keyboard or touch screen. For example, user 110 may select field 333 by tapping field 333 on the screen of client 120 and enter an amount user 110 wishes to pay by typing the amount.

Online banking application 210 or application 172 may identify fields and transactional data in real-time as a command is spoken by user 110 and cause pre-confirmation screen 330 to display identified fields and populate those fields with transactional data in real-time, in certain embodiments. For example, if a user speaks the command “Pay Entity A 500 dollars on October 31st from my checking account,” pre-confirmation screen 330 may display field 331 and populate it with transactional data “Entity A” as soon as user 110 speaks “Pay Entity A.” Pre-confirmation screen 330 may then display field 333 and populate it with transactional data “$500” as soon as user 110 speaks “500 dollars.” Next, pre-confirmation screen 330 may display field 334 and populate it with transactional data “Oct. 31” when user 110 speaks “on October 31st.” Finally, pre-confirmation screen 330 may display field 332 and populate it with transactional data “Account XXXX” when user 110 speaks “from my checking account.”

Pre-confirmation screen 330 may display a complete transaction button 335 and a cancel button 336. Cancel button 336 may be selected by user 110 and may operable to cause online banking application 210 to delete an interpreted spoken command and receive a new spoken command from user 110. In alternative embodiments, user 110 may speak a phrase such as “Cancel” or “Stop” to allow user 110 to speak a different or corrected command.

Complete transaction button 335 may allow user 110 to complete a transaction as displayed on pre-confirmation screen 330. User 110 may select complete transaction button 335 to complete a transaction. Complete transaction button 335 may display text, such as “Make Payment,” that depends on the type of transaction identified in a spoken command, in certain embodiments. In alternative embodiments, user 110 may speak a phrase such as “complete transaction” or “make payment” to accomplish the same result as selecting complete transaction button 335.

Selecting complete transaction button 335 may cause client 120 to send request 190 to server 150. Request 190 may contain information needed to complete an online banking transaction. As discussed above with regard to FIG. 1, upon receiving request 190, server 150 may send response 195, such as a transaction confirmation, to client 120. In the event that request 190 is for a transaction that is a payment or otherwise involves an entity 140, server may send response 196 to entity 140 in response to request 190.

Online banking application 210 may display confirmation screen 340 when client 120 receives response 195. Confirmation screen 340 may display a confirmation message 341, to let user 110 know the online banking transaction has been completed. Confirmation message 341 may be customized based on the type of transaction. For example, confirmation message 341 may contain the text “Payment Scheduled” for a payment that is scheduled in the future and/or “Payment Complete” once the payment has been completed. Similarly, confirmation message 341 may contain the text “Transfer Scheduled” for a transfer scheduled in the future and/or “Transfer Complete” once the transfer has been completed. In some embodiments, confirmation message 341 may be generic (e.g., “Transaction Scheduled” or “Transaction Complete”).

Confirmation screen 340 may also display confirmation details 342, which provide details of the online banking transaction. For example, confirmation details 342 may include the fields and transactional data as displayed in pre-confirmation screen 332, as well as other details of the transaction, such as a confirmation number, a time the transaction was recorded, and an amount of funds left in a particular account after the transaction has completed.

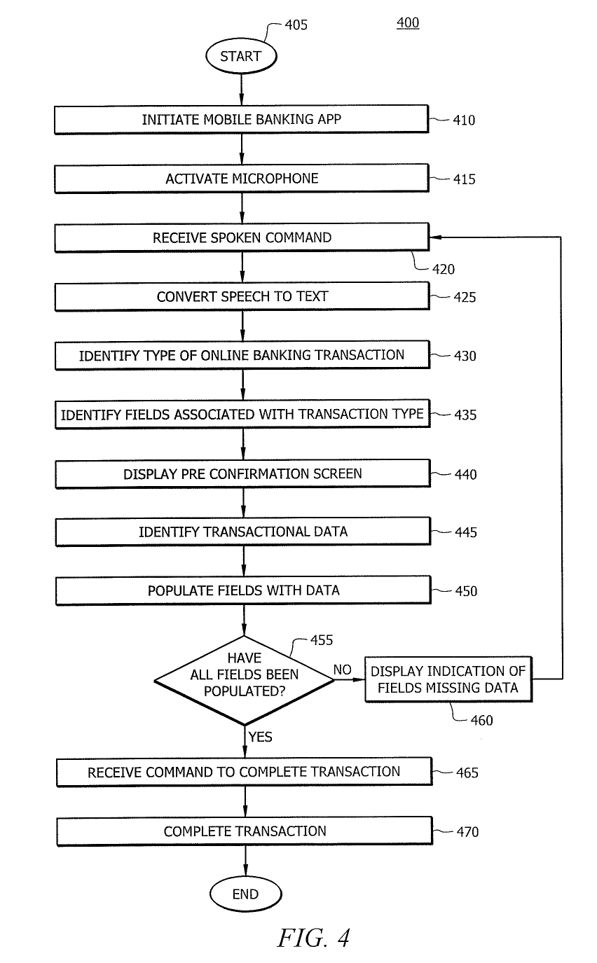

FIG. 4 illustrates an example flowchart for conducting an online banking transaction using voice commands. The method begins at step 410 where a user 110 initiates an online banking application 210. In some embodiments, the user 110 may prepare client 120 by installing an online banking application on a smartphone, a personal digital assistant (PDA), a laptop computer, or other computing device associated with user 110. The application may be downloaded from a website or obtained from any other suitable source. In some embodiments, the buyer may pre-configure the online banking application with personalized information, such as a password for accessing the application, buyer preferences, and/or account information, and so on. The configuration information may be stored locally on client 120 (e.g., data 215) or remotely, for example, in a database associated with a server operable to facilitate online banking transactions (e.g., data 164). Once client 120 has been prepared user 110 may initiate online banking application 210 by entering the appropriate input into client 120, such as selecting an icon for online banking application 210 on the screen of client 120 or by verbally initiating online banking application 210.

At step 415, online banking application 210 receives a command to activate microphone 125. This command may be a touch by user 110 of voice command icon 415. Alternatively, online banking application 210 may be configured to activate microphone 125 as soon as online banking application is initiated in step 410.

At step 420, online banking application 210 may receive a spoken command. The spoken command may describe an online banking transaction. For example, user 110 may speak a command such as, “Pay Phone Company A 50 dollars on October 31 from my checking account.”

At step 425, online banking application 210 may convert the spoken command into text. Alternatively, at step online banking application 210 may communicate the spoken command to server 170 as request 192 and application 172 may convert the spoken command into text.

At step 430, online banking application 210 or application 172 may identify a type of online banking transaction described by the spoken command. Online banking application 210 or application 172 may identify a type of online banking transaction by parsing the text of the command. In certain embodiments, online banking application 210 or application 172 may identify a type of transaction by recognizing key phrases in the parsed text. For example, the phrase “pay” may indicate that the transaction is a payment, and “transfer” may indicate that the transaction is a transfer.

If, at step 430, the spoken command does not contain enough information to identify a type of online banking transaction, online banking application 210 or application 172 may return a message prompting user 110 for more information. Online banking application 210 or application 172 may also identify transactional data (e.g. a date or amount of money) from the spoken command and save this transactional data for use in populating a field associated with a transaction type when the transaction type is identified. For example, if user 110 says “June 6th,” online banking application 210 or application 172 may return a message such as, “what would you like to do on June 6?” User 110 may reply by saying, for example, “Pay Phone Company A 50 dollars from my checking account.” Online banking application 210 or application 172 may then identify the transaction type as a payment transaction. Online banking application 210 or application 172, may use the date “June 6” as transactional data to populate a date field associated with the payment transaction as described below.

At step 435, online banking application 210 or application 172 may identify fields associated with the transaction type identified in step 430. Online banking application 210 or application 172 may identify fields associated with a transaction type based on stored fields associated with each transaction type. For example, online banking application 210 or application 172 may determine that the fields required to make a payment transaction include “pay to” information, “pay from” information, a monetary amount, and/or a payment date as shown in fields 331-334 of FIG. 3. Alternatively, online banking application 210 or application 172 may identify fields based on data in the spoken command. Online banking application 210 or application 172 may identify these fields by parsing the text generated at step 425. As an example, online banking application 210 may receive the spoken command “Pay $50 to Phone Company A.” Online banking application 210 or application 172 may identify that the spoken command contains the monetary amount field ($50) and the “pay to” field (Phone Company A), but does not contain the “pay from” or payment date fields. In response to a determination that the spoken command does not include the “pay from” and payment date fields, online banking application 210 may populate these fields with pre-configured default values. For example, user 110 may configure mobile application 210 to populate the “pay from” field with user 110's checking account and to populate the payment date with the current date. User 110 may choose to override the default configurations manually or by providing further spoken commands. Alternatively, in response to determining that the spoken command does not include the “pay from” and payment date fields, online banking application 210 may leave these fields blank to alert user 110 that additional information is needed before user 110 may complete the transaction.

At step 440 online banking application 210 may display pre-confirmation screen 330. If online banking application 210 or application 172 have not identified transactional data contained in the spoken command, pre-confirmation screen 330 may display blank fields, thereby prompting user 110 for the information needed to complete the transaction.

At step 445, online banking application 210 or application 172 may identify transactional data contained in the spoken command. Online banking application 210 or application 172 may identify transactional data by parsing the text generated in step 425. Online banking application 210 or application 172 may also associate the identified transactional data with appropriate identified fields.

At step 450, online banking application 210 may populate the fields identified in step 435 with the transactional data identified in step 445. Online banking application 210 may display or update pre-confirmation screen 330, displaying fields that have been populated with identified transactional data. If, at step 455, not all fields have been populated, online banking application 210 may display an indication of fields missing transactional data at step 460 and return to step 420 to receive additional spoken commands.

If, at step 455, all fields have been populated, online banking application 210 may proceed to step 465 to display pre-confirmation screen 330 showing all fields populated with the transactional data associated with each field and receive a command to complete the transaction. In certain embodiments, user 110 may select complete transaction button 335 to complete the transaction. Alternatively, user 110 may speak a command to complete the transaction.

At step 470, online banking application 210 may complete the transaction. Online banking application 210 may cause client 120 to send request 190 to server 150. After sending request 190, client 120 may receive response 195. Response 195 may cause online banking application 210 to display confirmation screen 340. Confirmation screen 340 may indicate that the transaction is complete and display details of the transaction.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An apparatus, comprising:
a microphone operable to:
receive a spoken command;
one or more processors operable to:
communicate the spoken command to a server;
receive an interpretation of the spoken command from the server, wherein the interpretation of the spoken command comprises:
information identifying a type of online banking transaction;
information identifying one or more fields associated with the type of online banking transaction; and
information identifying transactional data included in the spoken command;
populate each of the one or more fields for which the spoken command includes transactional data with the respective transactional data associated with the each field; and
a display operable to:
display a pre-confirmation screen, wherein the pre-confirmation screen comprises the one or more fields populated with the respective transactional data.

2. The apparatus of claim 1, wherein the type of online banking transaction comprises a payment to an entity.

3. The apparatus of claim 1, wherein the one or more fields comprise a pay to field, a pay from field, a payment amount field, and a payment date field.

4. The apparatus of claim 1, wherein the transactional data comprises at least one of a name of an entity, a date, and an amount of money.

5. The apparatus of claim 1, wherein:
the interpretation of the spoken command further comprises text representing the spoken command; and
information identifying the transactional data is obtained by parsing the text.

6. The apparatus of claim 1, wherein:
the one or more processors is further operable to determine if one or more of the fields have not been populated with the respective transactional data; and
the display is further operable to display an indication of the one or more fields that have not been populated with the respective transactional data.

7. The apparatus of claim 1, wherein receiving a spoken command, communicating the spoken command, receiving an interpretation of the spoken command, populating each of the one or more fields, and displaying the pre-confirmation screen occur in real-time as the spoken command is received.

8. A non-transitory computer readable storage medium comprising logic, the logic, when executed by a processor, operable to:
receive a spoken command;
interpret the spoken command, wherein interpreting the spoken command comprises:
identifying a type of online banking transaction;
identifying one or more fields associated with the type of online banking transaction; and
identifying transactional data included in the spoken command;
populate each of the one or more fields for which the spoken command includes transactional data with the respective transactional data associated with each field; and
communicate information to display on a pre-confirmation screen, wherein the pre-confirmation screen comprises the one or more fields populated by the respective transaction data.

9. The logic of claim 8, wherein the type of online banking transaction comprises a payment to an entity.

10. The logic of claim 8, wherein the one or more fields comprise a pay to field, a pay from field, a payment amount field, and a payment date field.

11. The logic of claim 8, wherein the transactional data comprises at least one of a name of an entity, a date, and an amount of money.

12. The logic of claim 8, wherein:
interpreting the spoken command further comprises converting the spoken command into text; and
identifying the transactional data further comprises parsing the text.

13. The logic of claim 8, wherein the logic is further operable to:
determine if one or more of the fields have not been populated with the respective transactional data; and
display an indication of the one or more fields that have not been populated with the respective transactional data.

14. The logic of claim 8, wherein receiving a spoken command, interpreting the spoken command, populating each of the one or more fields, and communicating information to display on the pre-confirmation screen occur in real-time as the spoken command is received.

15. A method, comprising:
receiving a spoken command;
interpreting the spoken command, by a processor, wherein interpreting the spoken command comprises:
identifying a type of online banking transaction;
identifying one or more fields associated with the type of online banking transaction; and
identifying transactional data included in the spoken command;
populating each of the one or more fields for which the spoken command includes transactional data with the respective transactional data associated with each field; and
communicating information to display on a pre-confirmation screen, wherein the pre-confirmation screen comprises the one or more fields populated by the respective transaction data.

16. The method of claim 15, wherein the type of online banking transaction comprises a payment to an entity.

17. The method of claim 15, wherein the one or more fields comprises a pay to field, a pay from field, a payment amount field, and a payment date field.

18. The method of claim 15, wherein the transactional data comprises at least one of a name of an entity, a date, and an amount of money.

19. The method of claim 15, wherein:
interpreting the spoken command further comprises converting the spoken command into text; and
identifying the transactional data further comprises parsing the text.

20. The method of claim 15, further comprising:
determining if the one or more fields have been populated by the respective transactional data associated with the one or more fields; and
displaying an indication of the one or more fields that has not been populated with the respective transactional data.

21. The method of claim 15, wherein receiving a spoken command, interpreting the spoken command, populating each of the one or more fields, and communicating information to display on the pre-confirmation screen occur in real-time as the spoken command is received.
